(19) United States
(12) Patent Application Publication
(10) Pub. No.: US 2014/0267974 A1
(43) Pub. Date: Sep. 18, 2014

(54) DISPLAY APPARATUS

(71) Applicant: MITSUBISHI ELECTRIC CORPORATION, Tokyo (JP)

(72) Inventor: Masayuki KAWANO, Tokyo (JP)

(73) Assignee: MITSUBISHI ELECTRIC CORPORATION, Tokyo (JP)

(21) Appl. No.: 14/203,484

(22) Filed: Mar. 10, 2014

(30) Foreign Application Priority Data
Mar. 12, 2013 (JP) 2013-048589

(51) Int. Cl. G02F 1/1333

(52) U.S. Cl. CPC G02F 1/133308
USPC 349/58

(57) ABSTRACT

A display apparatus includes a liquid crystal display apparatus, a housing, and a protection plate. The protection plate includes glass and a resin member. The resin member is bonded to the glass. The resin member of the protection plate is removably fixed to the housing.

### BACKGROUND OF THE INVENTION

1. Field of the Invention

The present invention relates to a display apparatus including a protection plate.

2. Description of the Background Art

In recent years, liquid crystal display (Liquid Crystal Display: LCD) apparatuses are coming into wide use for their advantages, e.g., being lightweight and thin.

In a liquid crystal display panel included in a liquid crystal display apparatus, a glass substrate at which interconnects and electrodes are formed and a counter substrate are disposed in parallel to each other. Further, in the liquid crystal display panel, liquid crystal is interposed between the glass substrate and the counter substrate. To each of the opposite sides of the liquid crystal display panel, a polarizer is bonded. The display area of the liquid crystal display panel is formed by a multitude of pixels. As a signal that corresponds to a display image is applied to the pixels in the display area, the image is displayed. As the backlight that is installed on the back side of the liquid crystal display panel emits light, the display image is visually recognized by a viewer.

In this manner, the liquid crystal display apparatus is structured by the liquid crystal display panel that controls the transmittance of light for each pixel and the backlight. That is, the liquid crystal display apparatus is a so-called light-receiving type display apparatus, and used in various fields using this characteristic.

For example, liquid crystal display apparatuses are used as a display for a personal computer, an industrial apparatus, an in-vehicle display apparatus, a handy terminal, an advertisement displaying machine and the like. As the liquid crystal display apparatuses being used in such a variety of environments, there are many display apparatuses that include a protection plate for protecting the display apparatus from external shock. Japanese Patent Application Laid-Open No. 2006-251241 discloses the structure of a display apparatus that includes a protection cover (a protection plate).

In recent years, the liquid crystal display apparatuses having a protection plate also are strongly required to reduce the thickness thereof. Accordingly, as the structure of fixing the protection plate and the housing case, there exists a structure in which the protection plate is pressed by a frame case from the front side of the protection plate so as to be retained thereby (hereinafter also referred to as Structure A). However, since Structure A invites an increase in thickness of a liquid crystal display apparatus, it often cannot be used for the liquid crystal display apparatus.

Further, the member forming the protection plate is preferably a glass member. The glass member is characterized by its high surface hardness, scratch resistance, and fine texture. In the state where the protection plate is formed by a glass member, in the event of breakage of the glass member, it is desirable to prevent the glass from being scattered from the viewpoint of safety. Further, when the glass is broken, it is desirable that the broken glass (the protection plate) can be easily replaced.

### SUMMARY OF THE INVENTION

An object of the present invention is to provide a display apparatus that can achieve both securance of safety and ease of maintenance upon breakage of a protection plate using glass.

A display apparatus according to one aspect of the present invention includes: a liquid crystal display apparatus that has a display face displaying an image; a housing that stores the liquid crystal display apparatus; and a protection plate that covers the display face. The protection plate includes glass and a resin member bonded to the glass. The resin member of the protection plate is removably fixed to the housing.

According to the present invention, the resin member is bonded to the glass. Thus, even when the glass is broken, the glass can be prevented from being scattered. Therefore, safety can be secured. Further, the resin member of the protection plate is removably fixed to the housing. Therefore, the protection plate can be easily replaced when the glass of the protection plate is broken. Accordingly, the display apparatus attains ease of maintenance upon breakage of the protection plate using glass, that is, high maintainability.

Thus, both securance of safety and ease of maintenance upon breakage of the protection plate using glass can be attained.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view showing the schematic structure of a display apparatus according to a first preferred embodiment of the present invention;

FIG. 2 is a cross-sectional view of the display apparatus according to the first preferred embodiment of the present invention;

FIG. 3 is a cross-sectional view of a display apparatus according to Variation of the first preferred embodiment of the present invention;

FIG. 4 is an exploded perspective view showing the schematic structure of a display apparatus according to a second preferred embodiment of the present invention;

FIG. 5 is a cross-sectional view of the display apparatus according to the second preferred embodiment of the present invention;

FIG. 6 is a cross-sectional view of a display apparatus according to Variation of the second preferred embodiment of the present invention;

FIG. 7 is an exploded perspective view showing the schematic structure of a display apparatus according to a third preferred embodiment of the present invention;

FIG. 8 is a cross-sectional view of the display apparatus according to the third preferred embodiment of the present invention;

FIG. 9 is a cross-sectional view of a display apparatus according to Variation of the third preferred embodiment of the present invention;

FIG. 10 is an exploded perspective view showing the schematic structure of a display apparatus according to a fourth preferred embodiment of the present invention;

FIG. 11 is a cross-sectional view of the display apparatus according to the fourth preferred embodiment of the present invention; and

FIG. 12 is a cross-sectional view of a display apparatus according to Variation of the fourth preferred embodiment of the present invention.

### DESCRIPTION OF THE PREFERRED EMBODIMENTS

In the following, with reference to the drawings, a description will be given of preferred embodiments of the present invention. In the following description, an identical reference character is allotted to identical constituent elements. Such constituent elements are identically named and function identically. Accordingly, in some cases, a detailed description thereof may not be repeated.

Note that, the size, material, shape or relative position of constituent elements illustrated in the preferred embodiments are to be changed as appropriate in accordance with the structure or various conditions of the apparatus to which the present invention is applied, and the present invention is not to be limited by such illustrations. Further, the dimension of each constituent element in the drawings may be different from the actual dimension.

### First Preferred Embodiment

FIG. 1 is an exploded perspective view showing the schematic structure of a display apparatus 100 according to a first preferred embodiment of the present invention. FIG. 2 is a cross-sectional view of the display apparatus 100 according to the first preferred embodiment of the present invention.

With reference to FIGS. 1 and 2, the display apparatus 100 includes a protection plate 1, a liquid crystal display apparatus 7, a housing 8, and screws 9.

The protection plate 1 includes glass 2 and a resin member 4. The glass 2 has a plate-like shape. The glass 2 has a main surface 2a and a back surface 2b. The back surface 2b is the face that is opposite to the main surface 2a. The main surface of the protection plate 1 is the main surface 2a of the glass 2.

The resin member 4 is formed by a transparent resin such as polycarbonate, polyester, acrylic, or ABS. The resin member 4 has a plate-like portion 4a and rod-like portions 4b. The plate-like portion 4a has a plate-like shape. The plate-like portion 4a of the resin member 4 is bonded to the back surface 2b of the glass 2 by a transparent adhesive agent 3. That is, the resin member 4 is bonded to the glass 2. Thus, the protection plate 1 is formed.

That is, the glass 2 is provided on the main surface (front surface) side of the protection plate 1. On the back surface side of the protection plate 1, the resin member 4 is provided. The resin member 4 is a shape retaining portion that has a shape for retaining the liquid crystal display apparatus 7.

The liquid crystal display apparatus 7 has a display face 6 (a screen) that displays images. The protection plate 1 is disposed such that the back surface 2b of the protection plate 1 is opposed to the display face 6 of the liquid crystal display apparatus 7. That is, the protection plate 1 is provided so as to cover the display face 6 of the liquid crystal display apparatus 7. Thus, the resin member 4 of the protection plate 1 retains the liquid crystal display apparatus 7.

Between the protection plate 1 and the liquid crystal display apparatus 7, a space (hereinafter also referred to as a space A) is formed. The space A is filled with a translucent adhesive agent 5. Thus, the protection plate 1 is fixed to the liquid crystal display apparatus 7. Note that the space A may not be filled with the adhesive agent 5.

Note that, the glass 2 may be structured to function as a touch panel that corresponds to the display face 6 of the liquid crystal display apparatus 7.

The housing 8 stores the liquid crystal display apparatus 7 and the protection plate 1. A bottom face 8a of the housing 8 is provided with holes H1.

The resin member 4 of the protection plate 1 is removably fixed to the housing 8. More specifically, the resin member 4 of the protection plate 1 is fixed to the housing 8 by the fastening force of the screws 9. Further specifically, into the rod-like portions 4b of the resin member 4, the screws 9 that pass through the holes H1 of the housing 8 are inserted. That is, into the rod-like portions 4b, the screws 9 are inserted via the housing 8. Thus, the rod-like portions 4b fix the screws 9. That is, the rod-like portions 4b are screw fixing portions that fix the screws 9. Note that, the protection plate 1 can be separated from the housing 8 by removing the screws 9 from the rod-like portions 4b.

As described above, in the present preferred embodiment, the resin member 4 is bonded to the glass 2. Thus, when the glass 2 is broken, the glass can be prevented from being scattered. Therefore, safety can be secured. Further, the resin member 4 of the protection plate 1 is removably fixed to the housing 8. Therefore, the protection plate 1 can be replaced with ease when the glass 2 of the protection plate 1 is broken. Accordingly, the display apparatus 100 attains ease of maintenance upon breakage of the protection plate using glass, i.e., attains high maintainability.

Thus, both securance of safety and ease of maintenance upon breakage of the protection plate using glass can be attained.

Further, the resin member 4 is bonded to the glass 2. Thus, it becomes possible to provide the protection plate 1 having fine-texture glass on the front surface side with the function of preventing the glass from being scattered.

Still further, in the present preferred embodiment, the resin member 4 of the protection plate 1 is fixed to the housing 8 by the fastening force of the screws 9. Thus, the protection plate 1 can be strongly fixed to the housing 8.

Still further, as described above, the resin member 4 is bonded to the glass 2. Thus, provided that strong shock is given to the surface of the glass 2 whereby the glass 2 is broken, the glass can be prevented from being scattered. Further, in this case, the broken glass stays inside the housing 8. Thus, high safety can be secured.

Still further, by the structure described above, the protection plate 1 (the resin member 4) can be strongly fixed to the housing 8 without increasing the thickness of the display apparatus, and a display apparatus whose protection plate 1 can be easily replaced (repaired) can be provided.

### Variation of First Preferred Embodiment

Note that, the structure in which the protection plate is fixed to the resin member is not limited to the structure using screws. The structure in which the protection plate is fixed to the resin member in the following manner may be employed.

FIG. 3 is a cross-sectional view of a display apparatus 100A according to Variation of the first preferred embodiment of the present invention. With reference to FIG. 3, the display apparatus 100A is different from the display apparatus 100 shown in FIG. 1 in including a protection plate 1A in place of the protection plate 1 and a housing 8A in place of the housing 8, and not including the screws 9. Other structures of the display apparatus 100A are similar to those of the display apparatus 100 and, therefore, the detailed description thereof will not be repeated.

The protection plate 1A is different from the protection plate 1 in including a resin member 4A in place of the resin member 4. Other structures of the protection plate 1A are similar to those of the protection plate 1 and, therefore, the detailed description thereof will not be repeated.

The resin member 4A is different from the resin member 4 in that projecting portions 4c are formed at the rod-like portions 4b. Other structures of the resin member 4A are similar to those of the resin member 4 and, therefore, the detailed description thereof will not be repeated. The projecting portions 4c are formed by unevenness of the resin forming the resin member 4A.

The housing 8A is different from the housing 8 in the shape, in not including the holes H1, and in including holes H2. Other structures of the housing 8A are similar to those of the housing 8 and, therefore, the detailed description thereof will not be repeated.

The projecting portions 4c of the resin member 4A engage with the peripheral portion of the holes H2 at the housing 8A. Thus, the resin member 4A of the protection plate 1A is fixed to the housing 8A. Note that, the rod-like portions 4b are formed by resin. Therefore, the rod-like portions 4b have elasticity. Therefore, by deforming each rod-like portion 4b in the right-left directions, the projecting portion 4c and the peripheral portion of the hole H2 in the housing 8A can be disengaged from each other. That is, the resin member 4A of the protection plate 1A is removably fixed to the housing 8A.

By the structure described above, the display apparatus 100A according to Variation of the present preferred embodiment can achieve the effect similar to that achieved by the first preferred embodiment. That is, both securance of safety and ease of maintenance upon breakage of the protection plate using glass can be attained.

### Second Preferred Embodiment

FIG. 4 is an exploded perspective view showing the schematic structure of a display apparatus 101 according to a second preferred embodiment of the present invention. FIG. 5 is a cross-sectional view of the display apparatus 101 according to the second preferred embodiment of the present invention.

With reference to FIGS. 4 and 5, the display apparatus 101 is different from the display apparatus 100 shown in FIGS. 1 and 2 in including a housing 8N in place of the housing 8 and in further including a gasket 12. Other structures of the display apparatus 101 are similar to those of the display apparatus 100 and, therefore, the detailed description thereof will not be repeated.

The housing 8N is different from the housing 8 in the shape. Other structures of the housing 8N are similar to those of the housing 8 and, therefore, the detailed description thereof will not be repeated. The shape of the housing 8N is similar to that of the housing 8A shown in FIG. 3. Note that, in FIG. 4, the shape of the housing 8N is shown in a simplified manner.

Note that, the resin member 4 of the protection plate 1 is removably fixed to the housing 8N by the screws 9, by the structure similar to that of the first preferred embodiment.

The shape of the gasket 12 is a closed loop. The gasket 12 is formed by a material having elasticity (e.g., rubber).

Note that, with the display apparatus 100A according to Variation of the first preferred embodiment shown in FIG. 3, in the state where the liquid crystal display apparatus 7 and the protection plate 1A are stored in the housing 8A, a clearance is formed between the housing 8A and the resin member 4A.

Accordingly, in the display apparatus 101 according to the second preferred embodiment, the gasket 12 is provided such that the clearance formed between the housing 8N and the resin member 4 is packed with the gasket 12. Specifically, in the clearance, by the housing 8N and the resin member 4 clamping the gasket 12, the gasket 12 is compressed and the repulsion force of the gasket 12 causes the clearance to be packed by the gasket 12.

By the structure described above, the display apparatus 100A according to the present preferred embodiment can achieve, in addition to the effect achieved by the first preferred embodiment, the effect of preventing intrusion of water from the outside of the display apparatus 100A into the display apparatus 100A. That is, the display apparatus 100A has the waterproofing function.

That is, similarly to the first preferred embodiment, the display apparatus 100A can attain both securance of safety and ease of maintenance upon breakage of the protection plate using glass, and has the waterproofing function.

### Variation of Second Preferred Embodiment

Note that, the structure in which the protection plate is fixed to the resin member is not limited to the structure using screws. The structure in which the protection plate is fixed to the resin member in the following manner may be employed.

FIG. 6 is a cross-sectional view of a display apparatus 101A according to Variation of the second preferred embodiment of the present invention. With reference to FIG. 6, the display apparatus 101A is different from the display apparatus 100A shown in FIG. 3 in further including the gasket 12. Other structures of the display apparatus 101A are similar to those of the display apparatus 100A and, therefore, the detailed description thereof will not be repeated.

Similarly to the second preferred embodiment, the display apparatus 101A is provided with the gasket 12 such that a clearance formed between the housing 8A and the resin member 4A is packed with the gasket 12.

Note that, the resin member 4A of the protection plate 1A is removably fixed to the housing 8A by the projecting portions 4c, by the structure similar to that of Variation of the first preferred embodiment.

By the structure described above, the display apparatus 101A according to Variation of the present preferred embodiment can achieve the effect similar to that achieved by the second preferred embodiment.

### Third Preferred Embodiment

FIG. 7 is an exploded perspective view showing the schematic structure of a display apparatus 102 according to a third preferred embodiment of the present invention. FIG. 8 is a cross-sectional view of the display apparatus 102 according to the third preferred embodiment of the present invention.

With reference to FIGS. 7 and 8, the display apparatus 102 is different from the display apparatus 100 shown in FIGS. 1 and 2 in including a protection plate 1B in place of the protection plate 1. Other structures of the display apparatus 102 are similar to those of the display apparatus 100 and, therefore, the detailed description thereof will not be repeated.

The protection plate 1B is different from the protection plate 1 shown in FIGS. 1 and 2 in including a resin member 4B in place of the resin member 4. Other structures of the protection plate 1B are similar to those of the protection plate 1 and, therefore, the detailed description thereof will not be repeated. The protection plate 1B is provided so as to cover the display face 6 of the liquid crystal display apparatus 7.

The resin member 4B is different from the resin member 4 shown in FIGS. 1 and 2 in including a glass retaining portion 41a in place of the plate-like portion 4a. Other structures of the resin member 4B are similar to those of the resin member 4 and, therefore, the detailed description thereof will not be repeated. That is, the resin member 4B has the glass retaining portion 41a and the rod-like portions 4b. The resin member 4B is made up of the glass retaining portion 41a and the rod-like portions 4b which are integrally molded.

The glass retaining portion 41a has a plate-like portion 4a and a frame portion 4d. The shape of the frame portion 4d is a closed loop. The frame portion 4d is formed at the circumferential portion of the plate-like portion 4a. That is, the glass retaining portion 41a is shaped to retain the glass 2 by the frame portion 4d.

The back surface 2b of the glass 2 is bonded to the plate-like portion 4a of the resin member 4 by an adhesive agent 3. In this state, the frame portion 4d covers the circumference of the glass 2 so as to be exposed outside the display apparatus 102. That is, the frame portion 4d projects to the outside of the housing 8 (the display apparatus 102). Thus, the resin member 4B having the glass retaining portion 41a functions as a design case.

In connection with the display apparatus 102, the housing 8 stores the liquid crystal display apparatus 7 without storing the glass 2.

Note that, the resin member 4B of the protection plate 1B is removably fixed to the housing 8 by the screws 9, by the structure similar to that of the first preferred embodiment.

By the structure described above, in connection with the display apparatus 102 according to the present preferred embodiment, the resin member 4B having the glass retaining portion 41a is used as a design case. Thus, in addition to the effect achieved by the first preferred embodiment, the glass 2 and the resin member 4B (the design case) can realize stable exterior quality, with no step height which may be caused by uneven attachment of the housing 8. That is, both securance of safety and ease of maintenance upon breakage of the protection plate using glass can be attained, and furthermore, stable exterior quality can be realized.

Note that, it is also possible to apply the structure of the second preferred embodiment in which the gasket 12 is used to the display apparatus 102 according to the present preferred embodiment. In this case, in the display apparatus 102, the housing 8N is used in place of the housing 8. Further, the gasket 12 is provided such that a clearance formed between the housing 8N and the resin member 4B is packed with the gasket 12.

### Variation of Third Preferred Embodiment

Note that, the structure in which the protection plate is fixed to the resin member is not limited to the structure using screws. The structure in which the protection plate is fixed to the resin member in the following manner may be employed.

FIG. 9 is a cross-sectional view of a display apparatus 102A according to Variation of the third preferred embodiment of the present invention. With reference to FIG. 9, the display apparatus 102A is different from the display apparatus 100A shown in FIG. 3 in including a protection plate 1C in place of the protection plate 1A. Other structures of the display apparatus 102A are similar to those of the display apparatus 100A and, therefore, the detailed description thereof will not be repeated.

The protection plate 1C is different from the protection plate 1B shown in FIG. 8 in including a resin member 4C in place of the resin member 4B. Other structures of the protection plate 1C are similar to those of the protection plate 1B and, therefore, the detailed description thereof will not be repeated.

The resin member 4C is different from the resin member 4B in that projecting portions 4c are formed at the rod-like portions 4b. Other structures of the resin member 4C are similar to those of the resin member 4B and, therefore, the detailed description thereof will not be repeated.

Note that, the resin member 4C of the protection plate 1C is removably fixed to the housing 8A by the projecting portions 4c, by the structure similar to that of Variation of the first preferred embodiment.

By the structure described above, the display apparatus 102A according to Variation of the present preferred embodiment can achieve the effect similar to that achieved by the third preferred embodiment.

Note that, it is also possible to apply the structure of the second preferred embodiment in which the gasket 12 is used to the display apparatus 102A according to Variation of the present preferred embodiment. In this case, the gasket 12 is provided such that a clearance formed between the housing 8A and the resin member 4C is packed with the gasket 12.

### Fourth Preferred Embodiment

FIG. 10 is an exploded perspective view showing the schematic structure of a display apparatus 103 according to a fourth preferred embodiment of the present invention. FIG. 11 is a cross-sectional view of the display apparatus 103 according to the fourth preferred embodiment of the present invention.

With reference to FIGS. 10 and 11, the display apparatus 103 is different from the display apparatus 100 shown in FIGS. 1 and 2 in including a protection plate 1D in place of the protection plate 1, and including the housing 8N in place of the housing 8. Other structures of the display apparatus 103 are similar to those of the display apparatus 100 and, therefore, the detailed description thereof will not be repeated. The protection plate 1D is provided so as to cover the display face 6 of the liquid crystal display apparatus 7.

The protection plate 1D is different from the protection plate 1 shown in FIGS. 1 and 2 in further including a glass 16. Other structures of the protection plate 1D are similar to those of the protection plate 1 and, therefore, the detailed description thereof will not be repeated.

The glass 16 has a plate-like shape. The glass 16 is bonded to the back surface of the plate-like portion 4a of the resin member 4 by an adhesive agent 3. That is, the glass 16 is provided on the back surface side of the protection plate 1D. Accordingly, the glass 16 is provided between the plate-like portion 4a of the resin member 4 and the liquid crystal display apparatus 7. That is, the glass 16 is provided between the resin member 4 of the protection plate 1D and the liquid crystal display apparatus 7.

Note that, the resin member 4 of the protection plate 1D is removably fixed to the housing 8N by the screws 9, by the structure similar to that of the first preferred embodiment.

As described above, in the display apparatus 103 according to the present preferred embodiment, the glass 16 is provided on the back surface side of the protection plate 1D. Thus, outgassing from the resin material forming the resin member 4 can be prevented from forming bubbles by the gas intruding into the adhesive agent 5. Thus, a highly reliable display apparatus can be provided.

Further, the resin member 4 of the protection plate 1D is removably fixed to the housing 8N by the screws 9. Thus, the effect similar to that achieved by the first preferred embodiment can be achieved.

Note that, it is also possible to apply the structure of the second preferred embodiment in which the gasket 12 is used to the display apparatus 103 according to the present preferred embodiment. In this case, the gasket 12 is provided such that a clearance formed between the housing 8N and the resin member 4C is packed with the gasket 12.

Further, the display apparatus 103 according to the present preferred embodiment may be structured to include the resin member 4B according to the third preferred embodiment in place of the resin member 4. Thus, the effect similar to that achieved by the third preferred embodiment can be achieved. That is, it becomes possible to allow the resin member 4B having the glass retaining portion 41a to function as a design case.

Further, the display apparatus 103 may be structured to employ the housing 8 in place of the housing 8N.

### Variation of Fourth Preferred Embodiment

Note that, the structure in which the protection plate is fixed to the resin member is not limited to the structure using screws. The structure in which the protection plate is fixed to the resin member in the following manner may be employed.

FIG. 12 is a cross-sectional view of a display apparatus 103A according to Variation of the fourth preferred embodiment of the present invention. With reference to FIG. 12, the display apparatus 103A is different from the display apparatus 100A shown in FIG. 3 in including a protection plate 1E in place of the protection plate 1A. Other structures of the display apparatus 103A are similar to those of the display apparatus 100A and, therefore, the detailed description thereof will not be repeated.

The protection plate 1E is different from the protection plate 1D shown in FIG. 11 in including the resin member 4A in place of the resin member 4. Other structures of the protection plate 1E are similar to those of the protection plate 1D and, therefore, the detailed description thereof will not be repeated.

The resin member 4A is different from the resin member 4 in that the projecting portions 4c are formed at the rod-like portions 4b. Other structures of the resin member 4A are similar to those of the resin member 4 and, therefore, the detailed description thereof will not be repeated.

Note that, the resin member 4A of the protection plate 1E is removably fixed to the housing 8A by the projecting portions 4c, by the structure similar to that of Variation of the first preferred embodiment.

By the structure described above, the display apparatus 103A according to Variation of the present preferred embodiment can achieve the effect similar to that achieved by the fourth preferred embodiment.

Note that, it is also possible to apply the structure of the second preferred embodiment in which the gasket 12 is used to the display apparatus 103A according to Variation of the present preferred embodiment. In this case, the gasket 12 is provided such that a clearance formed between the housing 8A and the resin member 4A is packed with the gasket 12.

Further, in the display apparatus 103A according to Variation of the present preferred embodiment, the resin member 4C according to Variation of the third preferred embodiment may be used in place of the resin member 4A. Thus, the effect similar to that achieved by Variation of the third preferred embodiment can be achieved. That is, it becomes possible to allow the resin member 4C having the glass retaining portion 41a to function as a design case.

Note that, in connection with the present invention, the preferred embodiments and Variations of preferred embodiments may be freely combined, or the preferred embodiments and Variations of preferred embodiments may be modified or eliminated as appropriate, within the scope of the present invention.

For example, the structure in which the resin member of the protection plate is removably fixed to the housing is not limited to the structure according to the first preferred embodiment in which the screws 9 are used, or to the structure according to Variation of the first preferred embodiment in which the projecting portions 4c are used. The structure in which the resin member of the protection plate is removably fixed to the housing may be implemented by, for example, providing a recess portion to the resin member 4, and allowing a projecting portion provided at the housing to engage with the recess portion.

While the invention has been shown and described in detail, the foregoing description is in all aspects illustrative and not restrictive. It is therefore understood that numerous modifications and variations can be devised without departing from the scope of the invention.

What is claimed is:

1. A display apparatus comprising:
a liquid crystal display apparatus that has a display face displaying an image;
a housing that stores said liquid crystal display apparatus; and
a protection plate that covers said display face, wherein
said protection plate includes glass and a resin member bonded to said glass, and
said resin member of said protection plate is removably fixed to said housing.

2. The display apparatus according to claim 1, wherein
said resin member has a screw fixing portion into which a screw is inserted via said housing, and
said resin member of said protection plate is fixed to said housing by a fastening force of said screw.

3. The display apparatus according to claim 1, wherein
said housing is provided with a hole, and
said resin member has a projecting portion that engages with a peripheral portion of said hole of said housing.

4. The display apparatus according to claim 1, wherein
a clearance is formed between said housing and said resin member, and said display apparatus further comprises
a gasket with which said clearance is packed.

5. The display apparatus according to claim 1, wherein
said resin member has a frame portion that covers a circumference of said glass so as to be exposed outside said display apparatus.

6. The display apparatus according to claim 1, wherein
said protection plate further includes other glass that is provided between said resin member of said protection plate and said liquid crystal display apparatus.
